(19) United States
(12) Patent Application Publication
(10) Pub. No.: US 2014/0127984 A1
(43) Pub. Date: May 8, 2014

(54) Abrasive Sharpener with Integrated Fire Starter, Aerophone, and Light

(71) Applicants: Richard S. Smith, Hot Springs, AR (US); Louis Chalfant, Hot Springs, AR (US)

(72) Inventors: Richard S. Smith, Hot Springs, AR (US); Louis Chalfant, Hot Springs, AR (US)

(21) Appl. No.: 13/671,254

(22) Filed: Nov. 7, 2012

(51) Int. Cl. B25F 1/00; F21V 33/00

(52) U.S. Cl. CPC B25F 1/00; F21V 33/0084
USPC 451/461

(57) ABSTRACT

An abrasive sharpener having an integrated fire starter, light source and aerophone. The sharpener has a pair of sharpening slots, including a carbide slot having carbide abrasive elements and a ceramic slot having ceramic abrasive elements. An open cavity and an adjacent slot are formed in the housing and receive a pyrophoric rod assembly having a pyrophoric rod and attached handle. The pyrophoric rod assembly is selectively removable from the housing cavity and when removed serves as a fire starter through movement of the pyrophoric rod in the carbide slot to generate sparks.

### BACKGROUND OF THE INVENTION

1. Field of the Invention

This invention relates in general to outdoor tools and, more particularly, to a hand held, abrasive sharpener having integrated outdoor and survival components including a fire starter, whistle, and light.

2. Summary of the Prior Art

Numerous designs for portable abrasive sharpeners for serrated and straight edge knives and the like are known in the prior art. Some of the designs for hand held sharpeners have employed more than one sharpening capability. Such known designs, however, have not combined multiple abrasive sharpening elements in a small, hand held sharpener that can be readily transported and can produce highly effective sharpening results, whether to sharpen a straight edge or a serrated edge. In addition, known hand held knife sharpeners for outdoor uses have not incorporated survival and emergency components to provide fire starting, light and sound alert components as an economical portable assembly

### SUMMARY OF THE INVENTION

It is therefore an objective of this invention to provide an improved compact abrasive sharpener for knives and the like having multiple abrasive elements to sharpen a large variety of knives or other implements. The abrasive elements herein disclosed may be used to sharpen a large range of different knife designs, whether having straight or serrated edges and the like. The sharpener of the invention is easily transported by an individual from place to place and is hand held during a sharpening operation and use with its other functions to be described. At one abrasive station, the sharpener includes a carbide slot for the pre-setting of the sharpening angle of straight-edged blades. A ceramic slot is used for the final edge setting in the sharpening of straight edged blades. A diamond rod is also provided for sharpening serrated edges. The portable sharpener of the invention is further provided with integrated components highly useful in outdoor, survival and emergency situations. One of such components comprises a self-contained fire starter having a removable pyrophoric rod assembly. The rod assembly is fitted with a handle that facilitates removal of an attached rod from a storage cavity in the housing of the sharpener herein disclosed. The rod is formed from or is provided with an exterior coating of a known pyrophoric substance used to produce a high intensity spark when in contact with a suitable material. In the invention herein the carbide abrasive elements in the carbide slot are angled with respect to each other in a manner to allow the carbides to act as an integrated striker for the pyrophoric rod as well as a preset for the edge of a blade. No additional external striker is required, as the sharper herein provides a self-contained fire starting capability. The sharpener of the invention further incorporates a self-contained light source and signal audio signal device, such as an aerophone.

### BRIEF DESCRIPTION OF THE DRAWINGS

FIG. 1 is a front perspective view of the abrasive sharpener of the invention;

FIG. 1A is a front perspective view, with parts exploded, of the abrasive sharpener of FIG. 1 showing its pivoted abrasive rod in a position between internal storage and an extended sharpening position;

FIG. 2 is a front elevational view of the abrasive sharpener of FIG. 1;

FIG. 3 is an end elevational view of the pocket abrasive sharpener of FIG. 1A;

FIG. 4 is a bottom plan view of the abrasive sharpener of FIG. 1A;

FIG. 5 is front elevational view with of the abrasive sharpener of FIG. 1A with the front housing half removed; and

FIG. 6 is an end elevational view of the abrasive sharpener of FIG. 1 with the flint rod assembly inserted the housing.

### DESCRIPTION OF THE PREFERRED EMBODIMENT

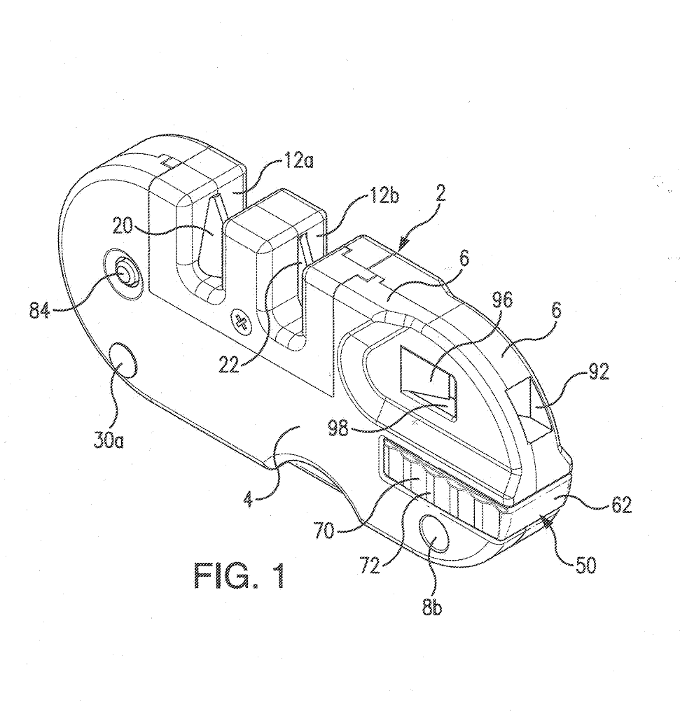

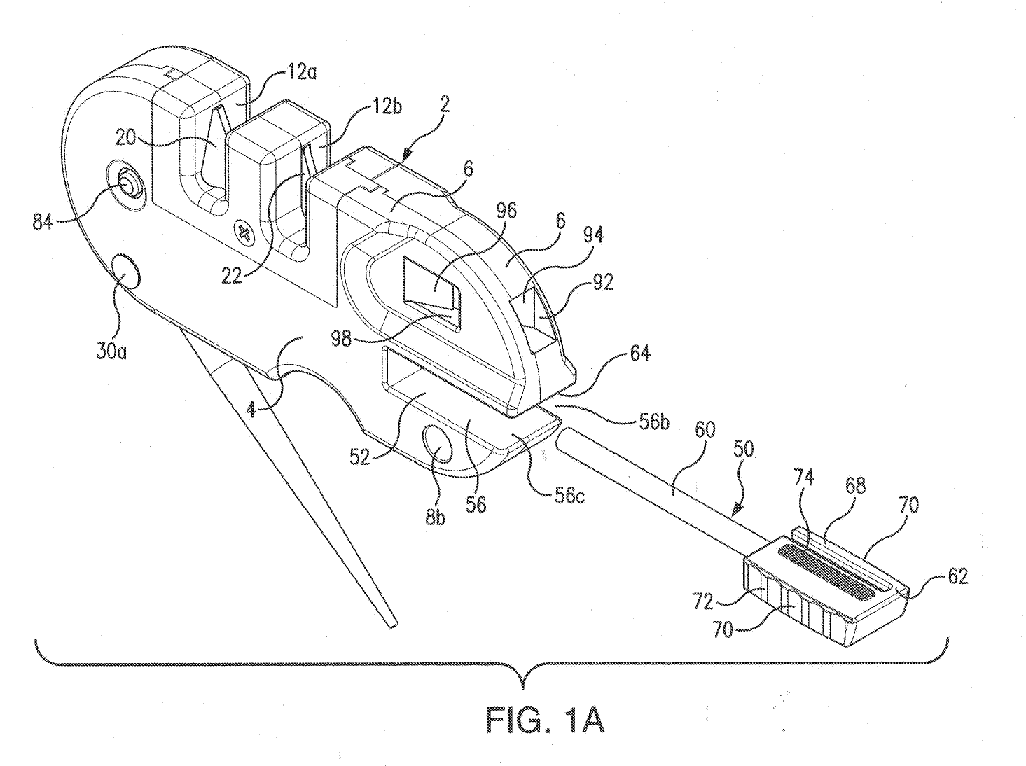

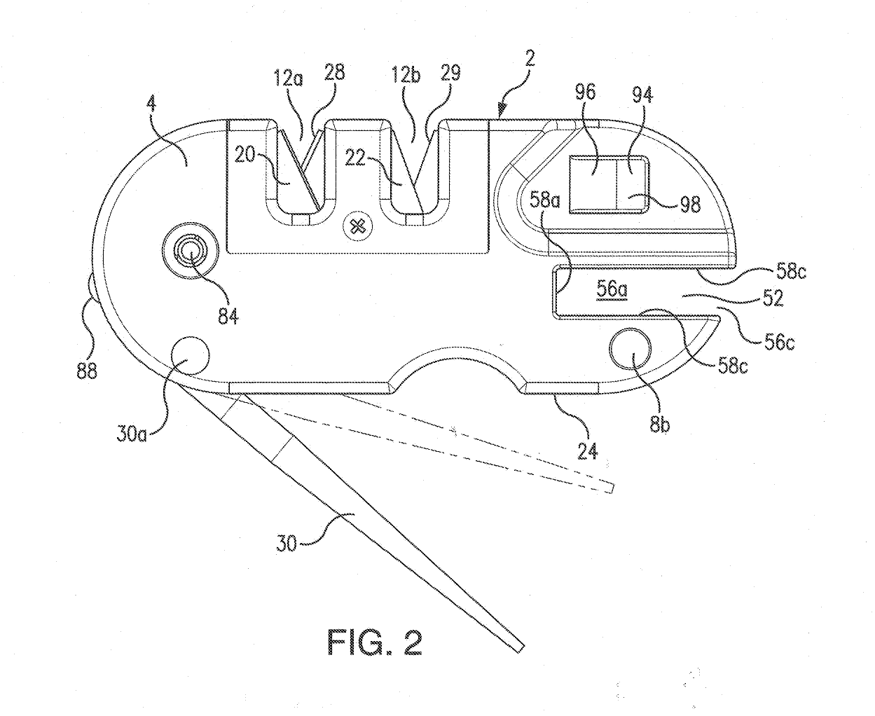

Referring now to FIGS. 1-5, there is illustrated the abrasive sharpener of the invention, generally designated by reference numeral 2. The abrasive sharpener 2 has a body 4 formed by a pair of contacting body halves 6. The pair of halves 6 may be fabricated from a suitable material, such as plastic, metal and the like and are retained together to form body 4 by an adhesive, welding, and other attachment technique. A lanyard whole 8b is provided at an end of housing 4. A recessed thumb depression 10 is formed on both of the body halves 6 at one end to form an area to allow the user to more firmly grip the sharpener during a sharpening task. A pair of lateral, side by side slots 12a, 12b, providing a pair of sharpening stations, are formed on the top of the body 4 to respectively receive overlapping offset flat blades 20 having a pair of carbide abrasive elements and a pair of ceramic abrasive elements 22.

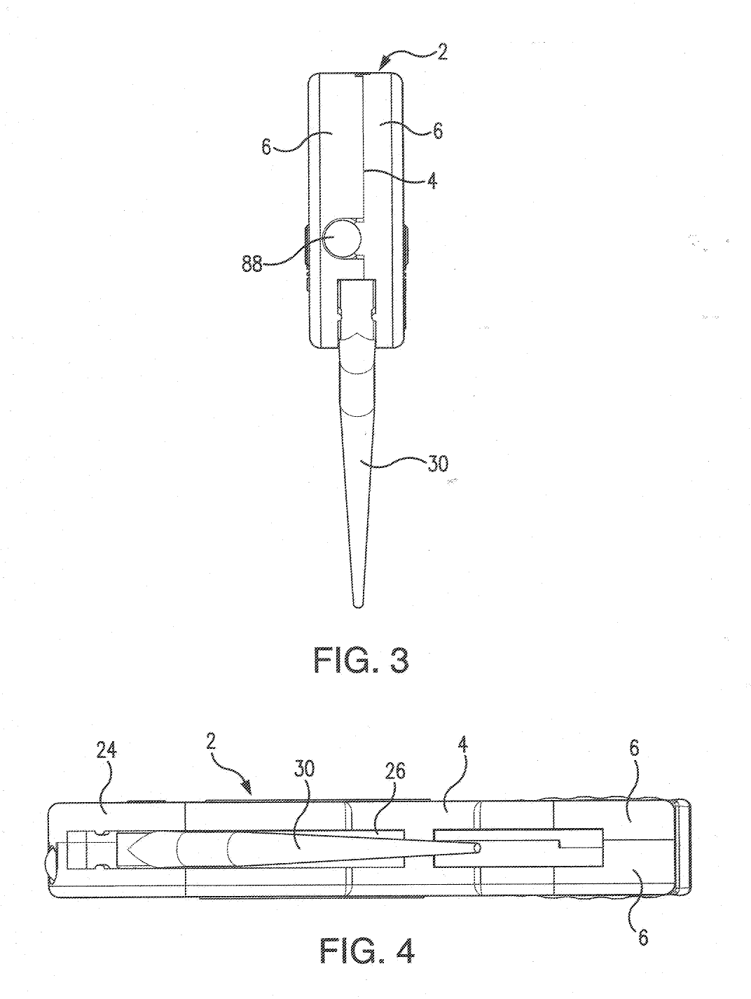

The bottom 24 of the sharpener body 4 (FIG. 4) is open and forms a storage compartment 26 to receive abrasive rod 30. The abrasive rod 30 is formed as a one piece member having a circular cross sectional shape generally along its length. The enlarged end of the rod 32 includes circular pivot member 34 and integral hollow to mount the rod 30 on pivot member 30a in compartment 26. The rod 24 is formed from a metal material, such as steel, aluminum, and the like. One or more layers of an abrasive grit, such as diamonds or other suitable abrasives, are provided on substantially all of the surface of the cylindrical tapered external surface to sharpen serrated blades when the tapered rod 30 is pivoted from storage position in compartment 22 (the rod being in intermediate pivoted position in FIG. A) to an extended outward position (not shown).

As seen in FIGS. 1, 1A, 2 and 5, the pair of abrasive carbide blades 20 and a pair of offset ceramic elements 22 are respectively positioned together in upper slots 12a and 12b to form respective generally V-shaped sharpening areas 28 and 29 accessible from the top of body 4. The carbide blades 20 are set at a generally V-shaped angle to create the preset of the angle of sharpening of the straight edge blade being moved through slot 12a. After being sharpened in slot 12a to a preset angle, the straight blade being sharpened is then sharpened in slot 12b by a V-shaped angle for the final edge setting for the blade being sharpened. Alternatively, each of the sharpening slots 12a and 12b can be alternatively or independently used to sharpen edges as needed. The carbide slot 12a can selectively serve as a striker to be used for starting fires in conjunction with a pyrophoric rod assembly 50 to be described. It is within the scope of the invention to use pyrophoric rod assembly 50 with other suitable surfaces serving as a striker when appropriate.

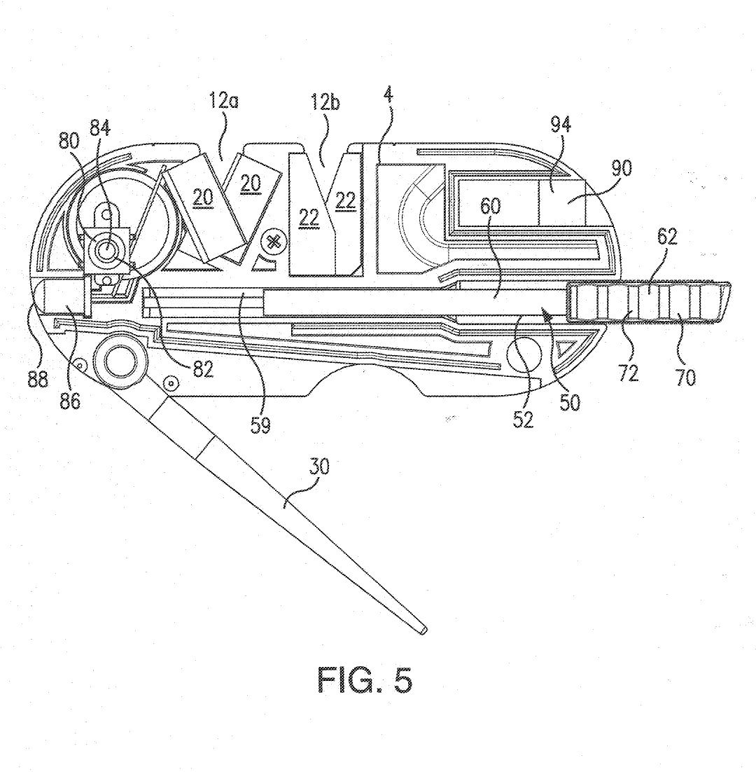

An open storage compartment having a lower cavity 52 is formed at housing end 54 and creates front and back openings 56a, b and front end opening 56c to the cavity 52. As seen in FIG. 5, the open storage compartment further includes an elongated internal slot 59 which opens through cavity back wall 58a. The body 4 has flat top and bottom walls 58b, 58c that are arranged parallel to each other and defining the upper and lower portions of cavity 52. The cavity 52 and internal slot 59 form the open storage compartment and are configured to correspond to the shape and dimensions of the pyrophoric rod assembly 50 to store the pyrophoric rod assembly 50 in the housing 4 when not removed for fire starting use.

The pyrophoric rod assembly 50 has a generally cylindrical rod 60 (FIGS. 1A and 5) which is a metal member having a conventional pyrophoric material applied substantially along its length. The pyrophoric substance used in connection with the invention is capable of generating fire starting sparks when in contact with a suitable fire starter surface as is well known. A handle 62 having a block-like configuration is attached to one end of pyrophoric rod 60. As an example of a technique of attachment, the handle 62 can be a thermal plastic co-molded to the end portion of the pyrophoric rod 60, although it is within the scope of the invention to use other handle material and methods of attachment. The configuration of the handle 62 is selected to generally correspond to the width, height and length of the cavity so that the handle 12 can be stored in cavity 52 for slidable movement therein. In the inserted storage position, the pyrophoric rod 60 is designed to be inserted into internal slot 59. The upper surface 58c of cavity 52 includes rib 64 that engages an open-ended slot 68 that is formed on the top of handle 62 to stabilize storage securement and movement of the handle 62 into and from the cavity 52, as well as maintaining proper orientation of the pyrophoric rod assembly 50 in housing 4 during storage. The opposed sides 70 of the handle 62 are provided with a plurality of round ridges 72 to form manual engagement surfaces which are externally exposed in the front and back openings 56a and 56b of cavity 52 in the stored position of the pyrophoric rod assembly within the housing 4. The engagement surfaces formed by ridges 72 facilitate insertion and removal of the flint rod assembly from and into cavity 52 for use. A strip of soft material 74, such as formed from a thermo plastic elastomer and the like, is molded on the upper surface of the handle 62 to serve as a thumb or finger engagement surface during use of the pyrophoric rod assembly 50. In addition the strip 74 aids in securing the pyrophoric rod assembly 50 in the cavity 52 of housing 4. In use the pyrophoric rod assembly 50 is removed from cavity 52 of body 4 and selectively is moved, when convenient in contact with the individual's thumb or finger on the strip material 74, through carbide slot 12a to generate sparks through contact with the surface of the carbide elements 20 or other striker surface to function as a fire starter to ignite a typical fire, whether outdoor or indoors, to wood, paper, kindling, leaves and the like.

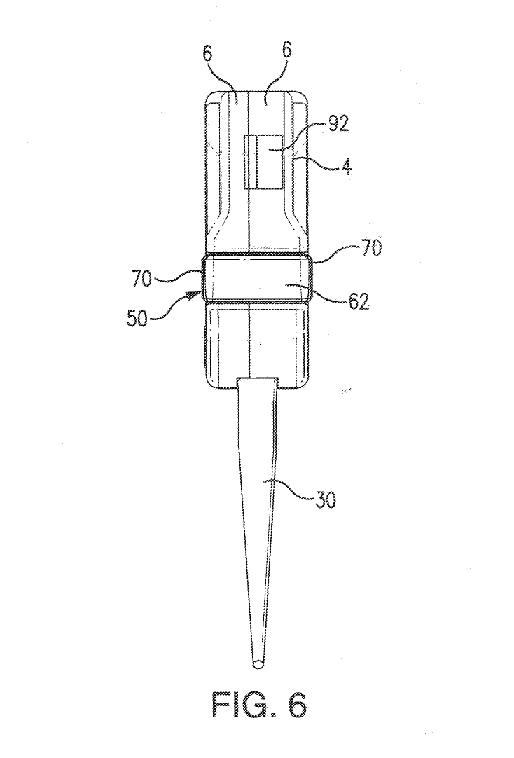

As seen in FIG. 5, a conventional switch assembly 80 having an internal battery (not shown) is mounted within housing 4 and includes a depressible actuator 82, such as well-known on/off push button 84. The push button 84 is exteriorly assessable through a hole in housing 4. The switch assembly 80 is electrically connected to light assembly 86 of a known design, which possesses an exterior light source in the form of a light source 88, such as a conventional LED or other suitable light element, and controls the on/off condition of the light source 88. A signaling device, such as aerophone 90, is integrally formed above cavity 52 and has a mouth air opening 92 (FIG. 6) adjacent an internal air passage 94, which has a closed end. Air blown into the mouth opening 92 is directed into the passage 94 split by labium 96 creating a turbulent vortex that causes the air to vibrate and create sound 6, and the air then exits out an adjacent outlet opening 98 formed on the side of housing 4. The aerophone 90 provides a loud sound that can be used in many situations, such as, for example, as an alert signal or a locator signal and the like. It is within the scope of the invention to use other signaling devices other than aerophone 90 in connection with housing 4, such as, for example, an electrically activated sound emitting device, a reflective exterior surface and other well-known devices capable of delivering a signal over a distance.

What is claimed is:

1. An abrasive sharpener comprising
a housing having at least one upper slot, said at least one upper slot including an abrasive element,
said housing including an open storage compartment,
a pyrophoric rod assembly being arranged to be stored in said open storage compartment and mounted in said open storage compartment for movement for selective removal, and
said pyrophoric rod assembly having a pyrophoric element for striking said a fire starting surface upon removal from said open storage compartment whereby said pyrophoric rod assembly acts as a fire starter.

2. The abrasive sharpener according to claim 1 wherein said fire starting surface is formed on said abrasive element.

3. The abrasive sharpener according to claim 1 wherein said pyrophoric element is a rod.

4. The abrasive sharpener according to claim 3 wherein a handle is attached to said pyrophoric rod.

5. The abrasive sharpener according to claim 4 wherein said handle and said pyrophoric rod generally have a configuration corresponding to said open storage compartment.

6. The abrasive sharpener according to claim 5 wherein said open storage compartment includes an internal slot for slidably receiving said pyrophoric rod and a cavity for slidably receiving said handle.

7. The abrasive sharpener according to claim 6 wherein the sides of said handle are externally exposed in said cavity for removal and insertion of said pyrophoric rod assembly.

8. The abrasive sharpener according to claim 6 wherein said housing includes a light assembly having an externally exposed light source.

9. The abrasive sharpener according to claim 7 wherein said housing has a signaling device.

10. The abrasive sharpener according to claim 9 wherein said signaling device is a sound producing device.

11. The abrasive sharpener according to claim 9 wherein said sound producing device is an aerophone.
